(19) United States
(12) Patent Application Publication
(10) Pub. No.: US 2016/0163128 A1
(43) Pub. Date: Jun. 9, 2016

(54) VEHICLE CONTROL DEVICE

(71) Applicant: HITACHI AUTOMOTIVE SYSTEMS, LTD., Ibaraki (JP)

(72) Inventor: Naoshi YAMAGUCHI, Yamato-shi, Kanagawa (JP)

(73) Assignee: HITACHI AUTOMOTIVE SYSTEMS, LTD., Hitachinaka-shi, Ibaraki (JP)

(21) Appl. No.: 14/904,514

(22) PCT Filed: Jul. 16, 2014
(86) PCT No.: PCT/JP2014/068925

§ 371 Date: Jan. 12, 2016

(30) Foreign Application Priority Data
Jul. 17, 2013 (JP) 2013-148690

(51) Int. Cl. G07C 5/08; G07C 5/02; B62D 5/04

(52) U.S. Cl. CPC G07C 5/08; B62D 5/049; G07C 5/02

(57) ABSTRACT

Provided is a vehicle control device improved in possibility of misdetection of a sensor failure. It is determined that output offset abnormality detection with respect to a steering angle sensor, a yaw rate sensor, and a lateral acceleration sensor can be performed when a tire slip amount is equal to or smaller than a predetermined value, and when it is determined that the output offset abnormality detection of each sensor can be performed, the output offset abnormality detection with respect to each sensor is performed.

### TECHNICAL FIELD

The invention relates to a vehicle control device.

### BACKGROUND ART

A technology of this kind is disclosed in the Patent Document 1 below. According to the Patent Document 1, a yaw rate detected by a yaw rate sensor, a yaw rate estimated from lateral acceleration detected by a lateral acceleration sensor, and a yaw rate estimated from a wheel angle detected by a wheel angle sensor are compared with one another while a vehicle is moving while the grip force of tires being within a linear region, to determine whether these yaw rates are correlated, and a failure of each sensor is detected on the basis of presence or absence of correlativity.

### CITATION LIST

### Patent Document

Patent Document 1: Japanese Unexamined Patent Application Publication (Kokai) No. 2002-053024

### SUMMARY OF INVENTION

### Technical Problem

The above-mentioned conventional technology, however, determines the correlativity from yaw rate differences based on the output of each sensor during the driving in the linear region. This might lead to misdetection of a sensor failure if, while driving in a non-linear region, the vehicle comes into a moving condition where it is temporarily impossible to discriminate the non-linear region from the linear region.

It is an object of the invention to provide a vehicle control device which is enhanced in accuracy of detection of a sensor failure.

Another object of the invention is to provide a vehicle control device in which the possibility of misdetection of a sensor failure can be reduced by enhancing accuracy in detection of a non-linear region.

### Solution to Problem

To accomplish the above objects, the vehicle control device according to the invention determines that output offset abnormality detection of a steering angle sensor, a yaw rate sensor, and a steering angle sensor can be performed when a tire slip amount is equal to or smaller than a predetermined value, and performs the output offset abnormality detection with respect to each sensor when it is determined that the output offset abnormality detection of each sensor can be performed.

### BRIEF DESCRIPTION OF DRAWINGS

FIG. 1 is a block diagram of an offset abnormality judgment processing unit according to an Embodiment 1.

FIG. 2 is a state transition diagram of a slip detection processing unit according to the Embodiment 1.

FIG. 3 is a state transition diagram of a linear motion judgment processing unit according to the Embodiment 1.

FIG. 4 is a state transition diagram of a steady motion judgment processing unit according to the Embodiment 1.

FIG. 5 is a state transition diagram of the offset abnormality judgment processing unit according to the Embodiment 1.

FIG. 6 is a state transition diagram of the offset abnormality judgment processing unit according to the Embodiment 1.

### DESCRIPTION OF EMBODIMENTS

### Embodiment 1

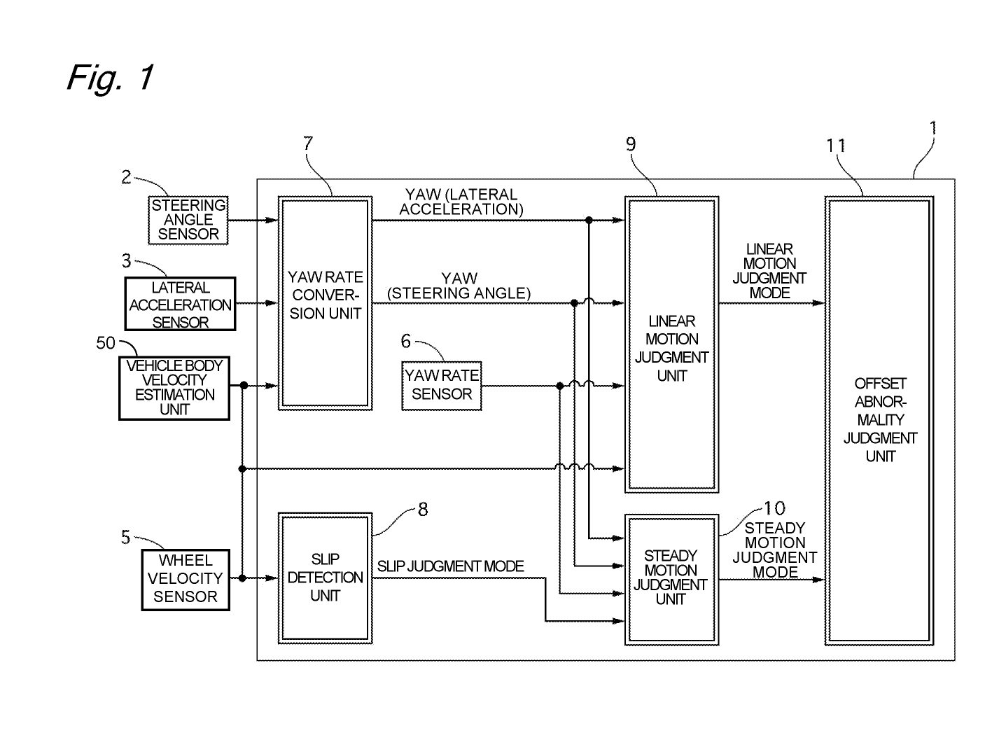

FIG. 1 is a block diagram of an offset abnormality judgment processing unit 1. The offset abnormality judgment processing unit 1 includes a yaw rate conversion processing unit 7, a slip detection processing unit 8, a linear motion judgment processing unit 9, a steady motion judgment processing unit 10, and an offset abnormality judgment processing unit 11.

[Yaw Rate Conversion Unit]

The yaw rate conversion processing unit 7 is inputted, for example, with a steering angle of a steering wheel, which is detected by a steering angle sensor 2, lateral acceleration acting on a vehicle, which is detected by a lateral acceleration sensor 3, and a vehicle body velocity which is calculated from a detected value (wheel velocity) detected by a wheel velocity sensor 5. A yaw rate (steering angle conversion yaw rate) acting on the vehicle is calculated from the steering angle and the vehicle body velocity. Also, a yaw rate (lateral acceleration conversion yaw rate) acting on the vehicle is calculated from the lateral acceleration. The vehicle body velocity is calculated, for example, by a vehicle body velocity estimation unit 50 illustrated in FIG. 1.

[Slip Detection Processing Unit]

The slip detection processing unit 8 is inputted with a wheel velocity of each wheel, which is detected by the wheel velocity sensor 5, and the vehicle body velocity calculated from the detected values detected by the wheel velocity sensor 5. The vehicle body velocity is calculated, for example, by the vehicle body velocity estimation unit 50 illustrated in FIG. 1. The vehicle body velocity can be estimated by the vehicle body velocity estimation unit from a detected value detected by a longitudinal acceleration sensor (not shown) for detecting the longitudinal acceleration of the vehicle.

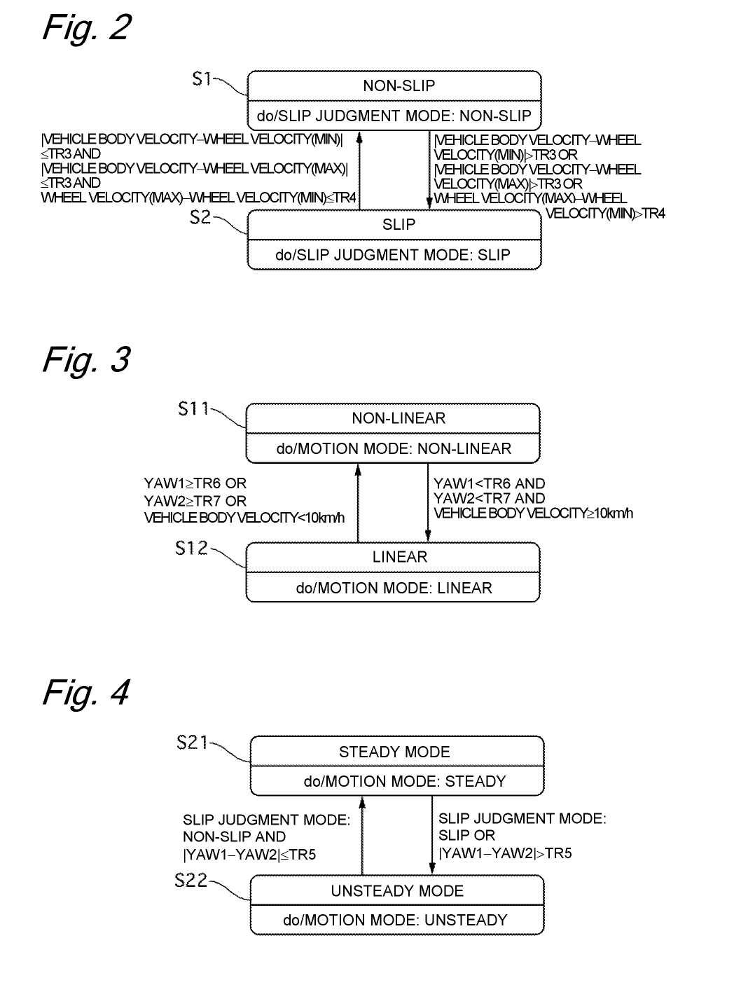

FIG. 2 is a state transition diagram of the slip detection processing unit 8.

The slip detection processing unit 8 transits to State S1 when an absolute value of a difference between the vehicle body velocity and a lowest wheel velocity of all wheel velocities of the vehicle is equal to or lower than a slip detection threshold value TR3, when an absolute value of a difference between the vehicle body velocity and a highest wheel velocity of all the wheel velocities is equal to or lower than the slip detection threshold value TR3, and when a difference between the highest and lowest wheel velocities of all the wheel velocities is equal to or smaller than a slip detection threshold value TR4. In State S1, a slip judgment mode is set to “Non-Slip”.

The slip detection processing unit 8 transits to State S2 when the absolute value of the difference between the vehicle body velocity and the lowest wheel velocity of all the wheel velocities is larger than the slip detection threshold value TR3, when the absolute value of the difference between the vehicle body velocity and the highest wheel velocity of all the wheel velocities is larger than the slip detection threshold value TR3, or when the difference between the highest wheel velocity (MAX) and the lowest wheel velocity (MIN) is larger than the slip detection threshold value TR4. In State S2, the slip judgment mode is set to “Slip”.

The difference between the vehicle body velocity and the lowest/highest wheel velocity of all the wheel velocities and the difference between the highest and lowest wheel velocities of all the wheel velocities each indicate a tire slip amount. According to the slip detection processing unit 8, the slip judgment mode is “Non-Slip” when the tire slip amount is equal to or smaller than a predetermined value (slip detection threshold value TR3).

[Linear Motion Judgment Processing Unit]

The linear motion judgment processing unit 9 is inputted with the vehicle body velocity calculated from the detected value detected by the wheel velocity sensor 5, a yaw rate detected by a yaw rate sensor 6 (detected yaw rate), the steering angle conversion yaw rate and the lateral acceleration conversion yaw rate from the yaw rate conversion processing unit 7, and the slip judgment mode from the slip detection processing unit 8. The vehicle body velocity is calculated, for example, by the vehicle body velocity estimation unit 50 illustrated in FIG. 1. The vehicle body velocity estimation unit 50 may be either an external or internal structure of the offset abnormality judgment processing unit 1. FIG. 3 is a state transition diagram of the linear motion judgment processing unit 9.

The linear motion judgment processing unit 9 transits to State S11 when a comparison signal YAW1 is equal to or larger than a linearity judgment threshold value TR6, when a comparison signal YAW2 is equal to or larger than a linearity judgment threshold value TR7, or when the vehicle body velocity is lower than 10 km. The comparison signals YAW1 and YAW2 may be two of the steering angle conversion yaw rate, the lateral acceleration conversion yaw rate, and the detected yaw rate, other than the one to be diagnosed. In State S11, a linearity judgment mode is set to “Non-Linear”.

The linear motion judgment processing unit 9 transits to State S12 when the comparison signal YAW1 is smaller than the linearity judgment threshold value TR6, when the comparison signal YAW2 is smaller than the linearity judgment threshold value TR7, and when the vehicle body velocity is equal to or higher than 10 km. In State S12, the linearity judgment mode is set to “Linear”.

[Steady Motion Judgment Processing Unit]

The steady motion judgment processing unit 10 is inputted with the detected yaw rate detected by the yaw rate sensor 6, the steering angle conversion yaw rate and the lateral acceleration conversion yaw rate from the yaw rate conversion processing unit 7, and the slip judgment mode from the slip detection processing unit 8. FIG. 4 is a state transition diagram of the steady motion judgment processing unit 10.

The steady motion judgment processing unit 10 transits to State S21 when the slip judgment mode is “Non-Slip”, and an absolute value of a difference between the comparison signals YAWL and YAW2 is equal to or smaller than a correlation failure detection threshold value TR5. In State S21, a motion mode is set to “Steady”.

The steady motion judgment processing unit 10 transits to State S22 when the slip judgment mode is “Slip” or when the absolute value of the difference between the comparison signals YAWL and YAW2 is larger than the correlation failure detection threshold value TR5. In State S22, the motion mode is set to “Unsteady”.

[Offset Abnormality Judgment Processing Unit]

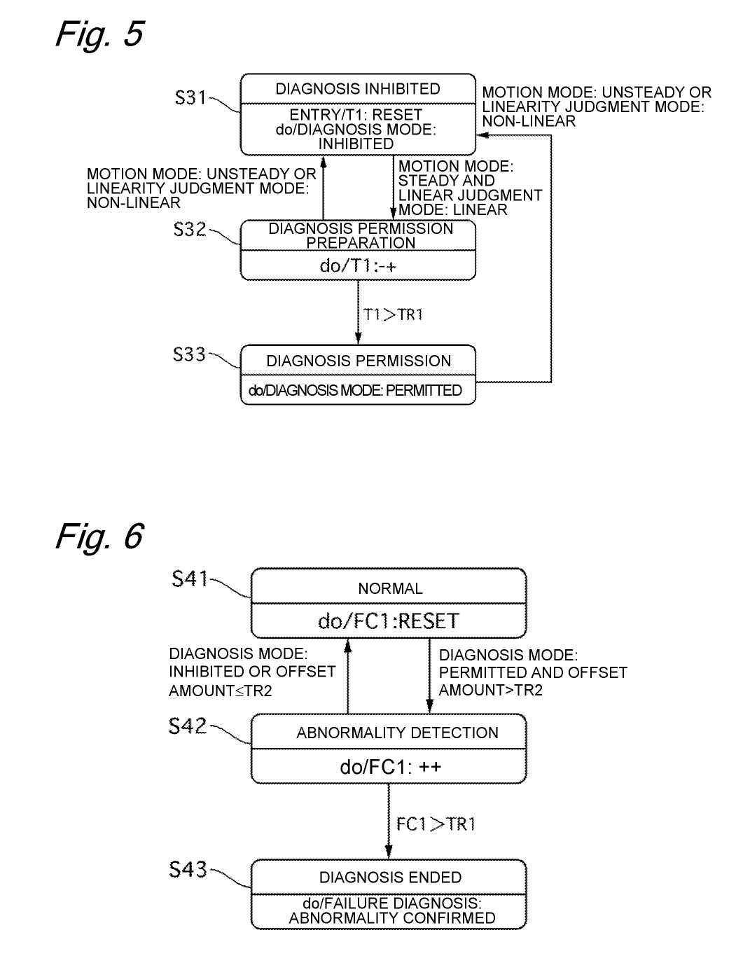

The offset abnormality judgment processing unit 11 is inputted with the linearity judgment mode from the linear motion judgment processing unit 9, and the steady motion judgment mode from the steady motion judgment processing unit 10. The offset abnormality judgment processing unit 11 performs diagnosis permission judgment processing and diagnosis processing. FIG. 5 is a state transition diagram of the diagnosis permission judgment processing. FIG. 6 is a state transition diagram of the diagnosis processing.

(Diagnosis Permission Judgment Processing)

The offset abnormality judgment processing unit 11 transits to State S31 when the motion mode is “Unsteady” or when the linearity judgment mode is “Non-Linear”. Referring to FIG. 5, when the motion mode is “Unsteady” or when the linearity judgment mode is “Non-Linear” in States S32 and S33, the offset abnormality judgment processing unit 11 transits from States S32 and S33 to State S31. In State S31, a diagnosis permission judgment time T1 is reset, and a diagnosis mode is set to “Inhibited”.

When the motion mode is “Steady”, and the linearity judgment mode is “Linear”, the offset abnormality judgment processing unit 11 transits to State S32. In State S32, the diagnosis permission judgment time T1 is incremented.

When the diagnosis permission judgment time T1 becomes larger than a diagnosis permission threshold value TR1, the offset abnormality judgment processing unit 11 transits to State S33. In State S33, the diagnosis mode is set to “Permitted”.

(Diagnosis Processing)

When the diagnosis mode is “Inhibited” or when an offset amount is equal to or smaller than an abnormality detection threshold value TR2, the offset abnormality judgment processing unit 11 transits to State S41. In State S41, an abnormality judgment time FC1 is reset. The offset amount here means each sensor value in a situation where a value to be detected is supposed to be zero.

When the diagnosis mode is “Permitted”, and the offset amount is larger than the abnormality detection threshold value TR2, the offset abnormality judgment processing unit 11 transits to State S42. In State S42, the abnormality judgment time FC1 is incremented.

When the abnormality judgment time FC1 becomes larger than the diagnosis permission threshold value TR1, the offset abnormality judgment processing unit 11 transits to State S43. In State S43, a failure judgment is set to “Abnormality Confirmed”.

[Operation]

It is possible to detect offset abnormality in the steering angle sensor 2, the lateral acceleration sensor 3, and the yaw rate sensor 6 when the vehicle moves in a linear manner. During the linear motion of the vehicle, the steering angle, the lateral acceleration, and the yaw rate are supposed to be substantially zero, so that the sensor values during the linear motion indicate offset amounts (zero drift). If any of the sensors indicates an offset amount larger than an allowable amount, the sensor has offset abnormality.

However, when the vehicle moves on a low μ path or a bank path, the sensor values can be large in some cases during the linear motion, despite that the sensors are normal. For instance, on the low μ path or the bank path, there is a situation where the vehicle moves linearly with the steering wheel operated. In this case, the steering angle is large in the low μ path, whereas the yaw rate and the lateral acceleration are indicated to be substantially zero. In the bank path, the steering angle and the lateral acceleration are large, while the yaw rate is substantially zero. In this way, if offset abnormality is simply intended to be detected during the linear motion, misdetection occurs as if there is offset abnormality in the steering angle sensor 2.

To solve the problem, an Embodiment 1 determines the performability of the offset abnormality detection on a condition not only that the vehicle moves in the linear manner, but also that the tire slip amount is equal to or smaller than the predetermined value.

This makes it possible to know the moving condition of the vehicle by paying attention to the tire slip amount. It is then possible to easily detect that the vehicle is in a stable linear moving condition, namely, that the vehicle is not moving on an unusual road, such as the low μ path or the bank path. An accurate offset abnormality detection is performed by detecting the offset abnormality of each sensor when the vehicle is in such a moving condition that the steering angle, the lateral acceleration, and the yaw rate are supposed to be substantially zero. By using a value estimated from the detected value of the longitudinal acceleration sensor as the vehicle body velocity and comparing the estimated value with each wheel velocity, it is possible to reliably detect a condition in which four wheels of a four-wheel-drive vehicle are slipping, and detect the tire slip amount without difficulty.

### Advantageous Effects

(1) There are provided the steering angle sensor 2 configured to detect a steering angle according to operation of the steering wheel installed in the vehicle; the lateral acceleration sensor 3 configured to detect the lateral acceleration acting on the vehicle; the yaw rate sensor 6 configured to detect the yaw rate acting on the vehicle; and an offset abnormality judgment processing unit 1 (detection judgment unit, output offset abnormality detection unit) configured to determine that the output offset abnormality detection with respect to the steering angle sensor 2, the lateral acceleration sensor 3, and the yaw rate sensor 6 can be performed when the tire slip amount is equal to or smaller than the predetermined value, and perform the output offset abnormality detection with respect to each sensor when it is determined that the output offset abnormality detection with respect to each sensor can be performed.

This enables an accurate offset abnormality detection with respect to the sensors.

(2) The offset abnormality judgment processing unit 1 includes the linear motion judgment processing unit 9 (linear motion judgment unit) configured to determine that the vehicle moves in the linear manner, and the steady motion judgment processing unit 10 (steady motion judgment unit) configured to determine that the vehicle moves in a steady manner when the tire slip amount is equal to or smaller than the predetermined value. When the vehicle moves in the linear and steady manner while the diagnosis permission judgment time T1 is equal to or larger than a diagnosis permission threshold value TR1, it is determined that the output offset abnormality detection can be performed. In other words, during the predetermined time period TR1, if the vehicle moves in the linear and steady manner, the output offset abnormality detection is permitted.

This enables an accurate offset abnormality detection with respect to the sensors.

### Other Embodiments

The present invention has been explained on the basis of the Embodiment 1. The specific configuration of each invention, however, is not limited to the Embodiment 1. It is therefore intended to include in the technical scope of the present invention all aspects added with design modifications and the like without deviating from the gist of the invention.

According to the Embodiment 1, for example, the slip detection processing unit 8 transits to State S1 when the difference between the vehicle body velocity and the lowest wheel velocity of all the wheel velocities is equal to or smaller than the slip detection threshold value TR3 (Condition 1), and the difference between the highest and lowest wheel velocities of all the wheel velocities is equal to or smaller than the slip detection threshold value TR4 (Condition 2). The slip judgment mode is then set to “Non-Slip”. It is also possible to employ only either one of the Conditions 1 or 2. The Condition 1 may be that “the difference between the vehicle body velocity and the highest wheel velocity of all the wheel velocities” is equal to or smaller than the slip detection threshold value TR3. It is also possible to determine whether “the difference between the vehicle body velocity and the lowest wheel velocity of all the wheel velocities” and “the difference between the vehicle body velocity and the highest wheel velocity of all the wheel velocities” are both equal to or smaller than the slip detection threshold value TR3 as illustrated in FIG. 2.

The tire slip amount of the slip detection processing unit 8 may be obtained in a different way than the one described in the Embodiment 1.

The above-described embodiment of the invention makes it possible to enhance accuracy in failure detection with respect to the sensors installed in the vehicle, and thus the possibility of misdetection of a sensor failure can be reduced.

(1) The vehicle control device according to one aspect of the invention is a vehicle control device for controlling a vehicle installed with a steering angle sensor configured to detect a steering angle according to operation of a steering wheel installed in the vehicle; a lateral acceleration sensor configured to detect lateral acceleration acting on the vehicle; and a yaw rate sensor configured to detect a yaw rate acting on the vehicle, the vehicle control device comprising:

a detection judgment unit configured to determine that output offset abnormality detection with respect to the steering angle sensor, the lateral acceleration sensor, and the yaw rate sensor can be performed when a tire slip amount is equal to or smaller than a predetermined value; and

an output offset abnormality detection unit configured to perform the output offset abnormality detection with respect to each sensor when the detection judgment unit determines that the output offset abnormality detection with respect to each sensor can be performed.

(2) In the vehicle control device according to one aspect of the invention, the detection judgment unit may be configured to determine that the vehicle moves in a steady manner when the vehicle moves in a linear manner and when the tire slip amount is equal to or smaller than the predetermined value, for a predetermined or longer period of time, and determine that the output offset abnormality detection can be performed.
(3) In the vehicle control device according to one aspect of the invention, a wheel velocity sensor configured to detect a wheel velocity of each wheel provided to the vehicle, and a vehicle body velocity estimation unit configured to calculate a vehicle body velocity from the detected wheel velocities may be installed in the vehicle, and the detection judgment unit may be configured to detect the tire slip amount on the basis of the detected wheel velocities and the calculated vehicle body velocity.
(4) In the vehicle control device according to one aspect of the invention, the detection judgment unit may be configured to determine that the tire slip amount is equal to or smaller than the predetermined value when difference between the calculated vehicle body velocity and a lowest wheel velocity among the detected wheel velocities is equal to or smaller than a predetermined value, and when difference between the calculated vehicle body velocity and a highest wheel velocity among the detected wheel velocities is equal to or smaller than a predetermined value.
(5) In the vehicle control device according to one aspect of the invention, the detection judgment unit may be configured to determine that the tire slip amount is equal to or smaller than the predetermined value when at least either one of first and second conditions is fulfilled, where the first condition is that difference between the calculated vehicle body velocity and a lowest wheel velocity among the detected wheel velocities is equal to or smaller than a predetermined value, and difference between the calculated vehicle body velocity and a highest wheel velocity among the detected wheel velocities is equal to or smaller than a predetermined value, and the second condition is that difference between the lowest and highest wheel velocities among the detected wheel velocities is equal to or smaller than a predetermined value.
(6) In the vehicle control device according to one aspect of the invention, the detection judgment unit may be configured to determine that the output offset abnormality detection can be performed when the calculated vehicle body velocity is equal to or higher than a predetermined vehicle body velocity.
(7) In the vehicle control device according to one aspect of the invention, the detection judgment unit may be configured to determine that the output offset abnormality detection can be performed when the vehicle moves in a linear manner at a predetermined or higher velocity, and the tire slip amount is equal to or smaller than the predetermined value, for a predetermined or longer period of time.
(8) A wheel velocity sensor configured to detect a wheel velocity of each wheel provided to the vehicle, and a vehicle body velocity estimation unit configured to calculate a vehicle body velocity from the detected wheel velocities may be installed in the vehicle, and the detection judgment unit may be configured to detect the tire slip amount on the basis of the detected wheel velocities and the calculated vehicle body velocity.
(9) In the vehicle control device according to one aspect of the invention, the detection judgment unit may be configured to determine that the tire slip amount is equal to or smaller than the predetermined value when difference between the calculated vehicle body velocity and a lowest wheel velocity among the detected wheel velocities is equal to or smaller than a predetermined value.
(10) In the vehicle control device according to one aspect of the invention, the detection judgment unit may be configured to determine that the tire slip amount is equal to or smaller than the predetermined value when difference between the calculated vehicle body velocity and a highest wheel velocity among the detected wheel velocities is equal to or smaller than a predetermined value.
(11) In the vehicle control device according to one aspect of the invention, the detection judgment unit may be configured to determine that the tire slip amount is equal to or smaller than the predetermined value when difference between lowest and highest wheel velocities among the detected wheel velocities is equal to or smaller than a predetermined value.
(12) The vehicle control device according to one aspect of the invention is a vehicle control device for controlling a vehicle installed with a steering angle sensor configured to detect a steering angle according to operation of a steering wheel installed in the vehicle, a lateral acceleration sensor configured to detect lateral acceleration acting on the vehicle, and a yaw rate sensor configured to detect a yaw rate acting on the vehicle, the vehicle control device comprising:

a slip amount calculation unit configured to calculate a tire slip amount;

a detection judgment unit configured to determine that output offset abnormality detection with respect to at least one of the sensors can be performed when the calculated tire slip amount is equal to or smaller than a predetermined value; and

an output offset abnormality detection unit configured to perform the output offset abnormality detection with respect to the at least one of the sensors when the detection judgment unit determines that the output offset abnormality detection with respect to each sensor can be performed.

(13) In the vehicle control device according to one aspect of the invention, the detection judgment unit may be configured to determine that the vehicle moves in a steady manner when the vehicle moves in a linear manner and the tire slip amount is equal to or smaller than the predetermined value, for a predetermined or longer period of time, and determines that the output offset abnormality detection can be performed.
(14) In the vehicle control device according to one aspect of the invention, a wheel velocity sensor configured to detect a wheel velocity of each wheel Provided to the vehicle, and a vehicle body velocity estimation unit configured to calculate a vehicle body velocity from the detected wheel velocities may be installed in the vehicle, and the slip amount calculation unit may be configured to detect the tire slip amount on the basis of the detected wheel velocities and the calculated vehicle body velocity.
(15) In the vehicle control device according to one aspect of the invention, the slip amount calculation unit may be configured to determine that the tire slip amount is equal to or smaller than the predetermined value when difference between the calculated vehicle body velocity and a lowest wheel velocity among the detected wheel velocities is equal to or smaller than a predetermined value, when difference between the calculated vehicle body velocity and a highest wheel velocity among the detected wheel velocities is equal to or smaller than a predetermined value, and when difference between the lowest and highest wheel velocities among the detected wheel velocities is equal to or smaller than a predetermined value.
(16) A vehicle control method according to one aspect of the invention is a vehicle control method for controlling a vehicle installed with a steering angle sensor configured to detect a steering angle according to operation of a steering wheel installed in the vehicle, a lateral acceleration sensor configured to detect lateral acceleration acting on the vehicle, and a yaw rate sensor configured to detect a yaw rate acting on the vehicle, wherein:

a slip condition of each wheel is calculated from a wheel velocity of the each wheel provided to the vehicle and a vehicle body velocity of the vehicle;

a determination is made as to whether output offset abnormality detection with respect to the steering angle sensor, the lateral acceleration sensor, and the yaw rate sensor can be performed according to the calculated slip condition; and

the output offset abnormality detection is performed on the basis of output of each sensor when it is determined that the output offset abnormality detection can be performed.

(17) The vehicle control method according to one aspect of the invention may be configured so that the output offset abnormality detection is performed when the calculated slip condition is equal to or smaller than a predetermined slip amount.
(18) The vehicle control method according to one aspect of the invention may be configured so that the output offset abnormality detection is performed after it is determined that the vehicle moves in a linear manner.
(19) The vehicle control method according to one aspect of the invention may be configured so that the slip condition is equal to or smaller than the predetermined slip amount when difference between the calculated vehicle body velocity and a lowest wheel velocity among the detected wheel velocities is equal to or smaller than a predetermined value, when difference between the calculated vehicle body velocity and a highest wheel velocity among the detected wheel velocities is equal to or smaller than a predetermined value, and when difference between the lowest and highest wheel velocities among the detected wheel velocities is equal to or smaller than a predetermined value.
(20) The vehicle control method according to one aspect of the invention may be configured so that it is determined that the output offset abnormality detection can be performed when the vehicle body velocity is equal to or higher than a predetermined vehicle body velocity.

The foregoing description merely explains several embodiments of the invention. However, those skilled in the art could easily understand that the embodiments described above may be changed or modified in various ways without substantially deviating from new teachings and advantages of the invention. Therefore, it is intended to include within the technological scope of the invention all aspects added with such changes or modifications.

The present patent application claims priority to Japanese Patent Application No. 2013-148690 filed on Jul. 17, 2013. The entire disclosure of Japanese Patent Application No. 2013-148690 filed on Jul. 17, 2013 including description, claims, drawings and abstract is incorporated herein by reference in its entirety.

The entire disclosure of Japanese Unexamined Patent Application Publication No. 2002-053024 (Patent Document 1) including description, claims, drawings and abstract is incorporated herein by reference in its entirety.

### REFERENCE SIGNS LIST

1 Offset abnormality judgment processing unit (detection judgment unit, output offset abnormality detection unit)
2 Steering angle sensor
3 Lateral acceleration sensor
6 Yaw rate sensor
9 Linear motion judgment processing unit (linear motion judgment unit)
10 Steady motion judgment processing unit (steady motion judgment unit)

1. A vehicle control device for controlling a vehicle installed with a steering angle sensor configured to detect a steering angle according to operation of a steering wheel installed in the vehicle, a lateral acceleration sensor configured to detect lateral acceleration acting on the vehicle, and a yaw rate sensor configured to detect a yaw rate acting on the vehicle, the vehicle control device comprising:
a detection judgment unit configured to determine that output offset abnormality detection with respect to the steering angle sensor, the lateral acceleration sensor, and the yaw rate sensor can be performed when a tire slip amount is equal to or smaller than a predetermined value; and
an output offset abnormality detection unit configured to perform the output offset abnormality detection with respect to each sensor when the detection judgment unit determines that the output offset abnormality detection with respect to each sensor can be performed.

2. The vehicle control device of claim 1, wherein:
the detection judgment unit is configured to determine that the vehicle moves in a steady manner when the vehicle moves in a linear manner and the tire slip amount is equal to or smaller than the predetermined value, for a predetermined or longer period of time, and determine that the output offset abnormality detection can be performed.

3. The vehicle control device of claim 2, wherein:
a wheel velocity sensor configured to detect a wheel velocity of each wheel provided to the vehicle, and a vehicle body velocity estimation unit configured to calculate a vehicle body velocity from the detected wheel velocities are provided to the vehicle, and
the detection judgment unit is configured to detect the tire slip amount on the basis of the detected wheel velocities and the calculated vehicle body velocity.

4. The vehicle control device of claim 3, wherein:
the detection judgment unit is configured to determine that the tire slip amount is equal to or smaller than the predetermined value when difference between the calculated vehicle body velocity and a lowest wheel velocity among the detected wheel velocities is equal to or smaller than a first predetermined value, and when difference between the calculated vehicle body velocity and a highest wheel velocity among the detected wheel velocities is equal to or smaller than the first predetermined value.

5. The vehicle control device of claim 3, wherein:
the detection judgment unit is configured to determine that the tire slip amount is equal to or smaller than the predetermined value when at least either one of first and second conditions is fulfilled, where the first condition is that difference between the calculated vehicle body velocity and a lowest wheel velocity among the detected wheel velocities is equal to or smaller than a first predetermined value, and difference between the calculated vehicle body velocity and a highest wheel velocity among the detected wheel velocities is equal to or smaller than the first predetermined value, and the second condition is that difference between the lowest and highest wheel velocities among the detected wheel velocities is equal to or smaller than a second predetermined value.

6. The vehicle control device of claim 5, wherein:
the detection judgment unit is configured to determine that the output offset abnormality detection can be performed when the calculated vehicle body velocity is equal to or higher than a predetermined vehicle body velocity.

7. The vehicle control device of claim 1, wherein:
the detection judgment unit is configured to determine that the output offset abnormality detection can be performed when the vehicle moves in a linear manner at a predetermined or higher velocity, and the tire slip amount is equal to or smaller than the predetermined value, for a predetermined or longer period of time.

8. The vehicle control device of claim 7, wherein:
a wheel velocity sensor configured to detect a wheel velocity of each wheel provided to the vehicle, and a vehicle body velocity estimation unit configured to calculate a vehicle body velocity from the detected wheel velocities are provided to the vehicle, and
the detection judgment unit is configured to detect the tire slip amount on the basis of the detected wheel velocities and the calculated vehicle body velocity.

9. The vehicle control device of claim 8, wherein:
the detection judgment unit is configured to determine that the tire slip amount is equal to or smaller than the predetermined value when difference between the calculated vehicle body velocity and a lowest wheel velocity among the detected wheel velocities is equal to or smaller than a first predetermined value.

10. The vehicle control device of claim 8, wherein:
the detection judgment unit is configured to determine that the tire slip amount is equal to or smaller than the predetermined value when difference between the calculated vehicle body velocity and a highest wheel velocity among the detected wheel velocities is equal to or smaller than a first predetermined value.

11. The vehicle control device of claim 8, wherein:
the detection judgment unit is configured to determine that the tire slip amount is equal to or smaller than the predetermined value when difference between lowest and highest wheel velocities among the detected wheel velocities is equal to or smaller than a second predetermined value.

12. A vehicle control device for controlling a vehicle installed with a steering angle sensor configured to detect a steering angle according to operation of a steering wheel installed in the vehicle, a lateral acceleration sensor configured to detect lateral acceleration acting on the vehicle, and a yaw rate sensor configured to detect a yaw rate acting on the vehicle, the vehicle control device comprising:
a slip amount calculation unit configured to calculate a tire slip amount;
a detection judgment unit configured to determine that output offset abnormality detection with respect to at least one of the sensors can be performed when the calculated tire slip amount is equal to or smaller than a predetermined value; and
an output offset abnormality detection unit configured to perform the output offset abnormality detection with respect to the at least one of the sensors when the detection judgment unit determines that the output offset abnormality detection with respect to at least one of the sensors can be performed.

13. The vehicle control device of claim 12, wherein:
the detection judgment unit is configured to determine that the vehicle moves in a steady manner when the vehicle moves in a linear manner and the tire slip amount is equal to or smaller than the predetermined value, for a predetermined or longer period of time, and determine that the output offset abnormality detection can be performed.

14. The vehicle control device of claim 12, wherein:
a wheel velocity sensor configured to detect a wheel velocity of each wheel provided to the vehicle, and a vehicle body velocity estimation unit configured to calculate a vehicle body velocity from the detected wheel velocities are provided to the vehicle, and
the slip amount calculation unit is configured to detect the tire slip amount on the basis of the detected wheel velocities and the calculated vehicle body velocity.

15. The vehicle control device of claim 14, wherein:
the slip amount calculation unit is configured to determine that the tire slip amount is equal to or smaller than the predetermined value when difference between the calculated vehicle body velocity and a lowest wheel velocity among the detected wheel velocities is equal to or smaller than a first predetermined value, when difference between the calculated vehicle body velocity and a highest wheel velocity among the detected wheel velocities is equal to or smaller than the first predetermined value, and when difference between the lowest and highest wheel velocities among the detected wheel velocities is equal to or smaller than a second predetermined value.

16. A vehicle control method for controlling a vehicle installed with a steering angle sensor configured to detect a steering angle according to operation of a steering wheel installed in the vehicle, a lateral acceleration sensor configured to detect lateral acceleration acting on the vehicle, and a yaw rate sensor configured to detect a yaw rate acting on the vehicle, wherein:
a slip condition of each wheel is calculated from a wheel velocity of the each wheel provided to the vehicle and a vehicle body velocity of the vehicle;
a determination is made as to whether output offset abnormality detection with respect to the steering angle sensor, the lateral acceleration sensor, and the yaw rate sensor can be performed according to the calculated slip condition; and
the output offset abnormality detection is performed on the basis of outputs of at least one of the sensors when it is determined that the output offset abnormality detection can be performed.

17. The vehicle control method of claim 16, wherein:
the output offset abnormality detection is performed when the calculated slip condition is equal to or smaller than a predetermined slip amount.

18. The vehicle control method of claim 17, wherein:
the output offset abnormality detection is performed after it is determined that the vehicle moves in a linear manner.

19. The vehicle control method of claim 18, wherein:
it is determined that the calculated slip condition is equal to or smaller than the predetermined slip amount when difference between the calculated vehicle body velocity and a lowest wheel velocity among the detected wheel velocities is equal to or smaller than a first predetermined value, when difference between the calculated vehicle body velocity and a highest wheel velocity among the detected wheel velocities is equal to or smaller than the first predetermined value, and when difference between the lowest and highest wheel velocities among the detected wheel velocities is equal to or smaller than a second predetermined value.

20. The vehicle control method of claim 19, wherein:
it is determined that the output offset abnormality detection can be performed when the vehicle body velocity is equal to or higher than a predetermined vehicle body velocity.
